(19) United States
(12) Patent Application Publication
(10) Pub. No.: US 2026/0012733 A1
(43) Pub. Date: Jan. 8, 2026

(54) STIFFNESS REDUCTION HINGES FOR AUDIO SPEAKERS

(71) Applicant: Apple Inc., Cupertino, CA (US)

(72) Inventors: Stuart M. NEVILL, Los Gatos, CA (US); Martial A. ROUSSEAU, Saratoga, CA (US); Onur I. ILKORUR, Santa Clara, CA (US); Bonnie W. TOM, Wheat Ridge, CO (US)

(21) Appl. No.: 19/189,215

(22) Filed: Apr. 24, 2025

Related U.S. Application Data
(60) Provisional application No. 63/667,123, filed on Jul. 2, 2024.

(51) Int. Cl. H04R 9/04; H04R 1/02; H04R 9/06

(52) U.S. Cl. CPC H04R 9/045; H04R 1/025; H04R 9/041; H04R 9/06

(57) ABSTRACT

Audio speakers include one or more hinges designed to provide stiffness cancellation and offset air trapped in a back volume of the audio speakers. The hinges are connected to a rear suspension of the audio speaker, including a voice coil, while allowing the voice coil to acoustically drive a diaphragm. The hinges are manufactured to imitate a resting position in the audio speaker when the hinges are connected installed in the audio speaker. As a result, the hinges undergo less stress. Alternatively, hinges may be connected to a front suspension of an audio speaker.

### CROSS REFERENCE TO RELATED APPLICATION(S)

The present application claims the benefit of U.S. Provisional Application No. 63/667,123, entitled “STIFFNESS REDUCTION HINGES FOR AUDIO SPEAKERS”, filed Jul. 2, 2024, the entirety of which is incorporated herein for reference.

### TECHNICAL FIELD

This application is directed to audio transducers, and more particularly, hinges that provide stiffness reduction for audio transducers.

### BACKGROUND

Audio transducers, such as audio speakers, typically include a front volume and a back volume separated by membrane that is movably suspended by a surround.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a perspective view of an example of an electronic device having an audio speaker, in accordance with one or more aspects of the present disclosure.

FIG. 2 illustrates a partial cross sectional view of a portion of an example electronic device having an audio speaker, in accordance with one or more aspects of the present disclosure.

FIG. 3 illustrates a top view of an audio speaker, in accordance with one or more aspects of the present disclosure.

FIG. 4 illustrates a bottom perspective view of an audio speaker, in accordance with one or more aspects of the present disclosure.

FIG. 5A illustrates a cross sectional view of the audio speaker, in accordance with one or more implementations of the present disclosure.

FIG. 5B illustrates an additional cross sectional side view of an audio speaker, showing an alternative implementation of the audio speaker, in accordance with one or more aspects of the present disclosure.

FIG. 6 illustrates a partial cross sectional view of an example of an audio speaker with several hinges, in accordance with one or more aspects of the present disclosure.

FIG. 7A and FIG. 7B illustrate partial cross sectional views of an audio speaker, showing exemplary movement of several components, in accordance with one or more aspects of the present disclosure.

FIG. 8 and FIG. 9 illustrate perspective views of alternate examples of audio speakers, in accordance with one or more aspects of the present disclosure.

FIG. 10 illustrates a perspective view of an audio speaker assembly, in accordance with one or more aspects of the present disclosure.

FIG. 11A, FIG. 11B, and FIG. 11C illustrate partial cross sectional views of an alternate example of an audio speaker, showing a hinge in a different location, in accordance with one or more aspects of the present disclosure.

FIG. 12 illustrates a side view of an example of a hinge, in accordance with one or more aspects of the present disclosure.

FIG. 13 illustrates a side view of an example of a hinge, showing a position of the hinge when assembled in an audio speaker, in accordance with one or more aspects of the present disclosure.

FIG. 14 illustrates a flow diagram of an example of a process for manufacturing a hinge, in accordance with one or more implementations of the present disclosure.

FIG. 15 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to hinges used to provide stiffness cancellation, or stiffness reduction, in an audio speaker (e.g., audio transducer). Several hinges are connected to a voice coil and form in part a rear suspension or a front suspension in the audio transducer. Additionally, audio speakers described herein may include stop mechanism, such as physical structures designed to contact and limit travel of the hinges, thus limiting travel of the voice coil. Additionally, the hinges provide a force that centers the audio transducer by, for example, maintaining the voice coil in a desired relationship with respect to a magnet of the audio speaker. In order to promote motion and reduced stress, the dimensions of the hinge may vary. For example, the ends of the hinge may be thinner than at the center of the hinge. Additionally, the hinge may be molded (e.g., injection molded), and in particular, molded in a shape that closely matches its resting position when connected to the audio speaker. As a result of the molded shape, applied stress on the hinge is reduced at its resting position.

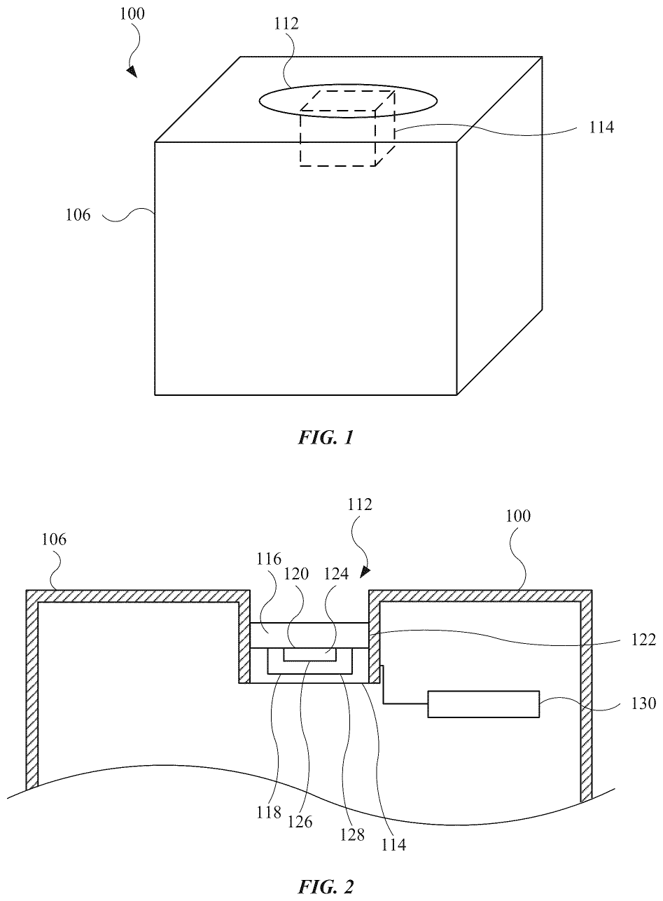

These and other embodiments are discussed below with reference to FIGS. 1-15. However, those skilled in the art will readily appreciate that the detailed description given herein with respect to these Figures is for explanatory purposes only and should not be construed as limiting.

FIG. 1 illustrates a perspective view of an example of an electronic device 100 having an audio speaker 114, in accordance with one or more aspects of the present disclosure. An illustrative electronic device including an audio transducer, such as an audio speaker, is shown in FIG. 1. The electronic device 100 may include a housing 106. In one or more implementations, the housing 106 may be configured to rest on a table, a shelf, a desk, a counter, or a floor. In one or more other implementations, the housing 106 may be sufficiently small to be portable and carried or worn by a user. In this regard, the electronic device 100 may take the form of a handheld electronic device such as a tablet computer, a laptop computer, an audio speaker such as a portable wireless audio speaker or a smart audio speaker, a cellular telephone or smartphone, or a wearable device such as a smart watch, a pendant device, a head mountable device, or the like. The configuration of the electronic device 100 of FIG. 1 is merely illustrative. In various implementations, the electronic device 100 may take the form of a computer such as a computer that is integrated into a display such as a computer monitor, a laptop computer, a media player, a gaming device, a navigation device, a computer monitor, a television, a headphone, an earbud, or other electronic equipment.

The housing 106 may include an opening 112. The opening 112 may form a port for an audio component. In one or more implementations, the opening 112 forms an audio speaker port for the audio speaker 114 disposed within the housing 106. As shown, the audio speaker 114 may be mounted directly adjacent to the opening 112. Alternatively, in one or more other implementations, the audio speaker 114 may be offset from the opening 112, and sound from the audio speaker 114 may be routed to and through the opening 112 by one or more internal device structures. The audio speaker 114 may take the form of an audio speaker or audio transducer designed to convert electrical energy to acoustical energy (e.g., audible sound).

In various implementations, the housing 106 may also include other openings, such as openings for one or more microphones, one or more pressure sensors, other sensors, one or more light sources, or other components that receive or provide signals from or to the environment external to the housing 106. Openings such as the opening 112 may be open ports, or may be completely or partially covered with a permeable membrane or a mesh structure that allows air and/or sound to pass through. Although the opening 112 and the audio speaker 114 represent a single opening and a single audio speaker, respectively, in FIG. 1, this is merely illustrative, and multiple openings and/or multiple audio speakers may be provided within the housing 106. In some implementations, one or more groups of openings in the housing 106 may be aligned with a single port of an audio component within the housing 106. The housing 106, which may sometimes be referred to as a case, may be formed of plastic, glass, ceramics, fiber composites, metal (e.g., stainless steel, aluminum, etc.), other suitable materials, or a combination of any two or more of these materials. In one or more implementations, the housing 106 may include one or more interfaces for mechanically coupling the housing 106 to a strap or other structure for securing the housing 106 to a user/wearer.

In one or more implementations, the electronic device 100 may also include a display (not shown) mounted to or within the housing 106. The electronic device 100 may include one or more input/output devices such as a touch screen incorporated into a display, a button, a switch, a dial, a crown, and/or other input output components disposed on or behind the housing and/or the display. The housing 106 and/or a display may include one or more openings to accommodate a button, an audio speaker, a light source, or a camera (as examples).

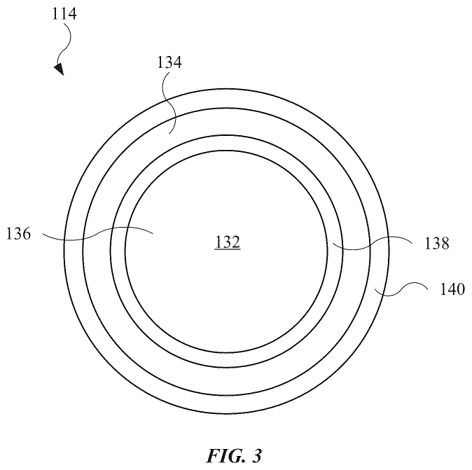

FIG. 2 illustrates a partial cross sectional view of a portion of the electronic device 100, in accordance with one or more aspects of the present disclosure. In this example, the audio speaker 114 may include a front volume 116 and a back volume 118. The front volume 116 and the back volume 118 may be separated by a sound-generating component 120 (e.g., a diaphragm, membrane, or an actuatable component of a microelectromechanical systems (MEMS) audio speaker). The front volume 116 may be fluidly and acoustically coupled to the opening 112 in the housing 106. The front volume 116 and/or the back volume 118 may be formed, in whole or in part by an audio speaker housing 122. As shown, the audio speaker housing 122 is disposed within the housing 106 of the electronic device 100. In one or more other implementations, the housing 106 may form part or all of the audio speaker housing 122 for the audio speaker 114. In one or more implementations, the back volume 118 may be a sealed back volume that is bounded, in part, by the audio speaker housing 122 and/or the sound-generating component 120.

The audio speaker 114 may include audio speaker circuitry 124. The audio speaker circuitry 124 may include, for example, a voice coil 126, a magnet 128, and/or other audio speaker circuitry. The magnet 128 may take the form of a permanent magnet formed from neodymium or another rare Earth magnet, as non-limiting examples. In one or more implementations, the magnet 128 may take the form of a fixed magnet (e.g., stationary magnet within the audio speaker 114). Alternatively (as discussed below), the magnet 128 may take the form of a movable magnets. In one or more implementations, the electronic device 100 may also include other circuitry, such as device circuitry 130, which may include one or more processors, memory, acoustic components, haptic components, mechanical components, electronic components, or any other suitable components of an electronic device. Additionally, the device circuitry 130 may also include one or more sensors, such as an inertial sensor (e.g., one or more accelerometers, gyroscopes, and/or magnetometers), a heart rate sensor, a blood oxygen sensor, a positioning sensor, a microphone, and/or the like. In one or more implementations, the device circuitry 130 may generate, based on audio content to be output by the audio speaker 114, a current (e.g., electrical current) through the voice coil 126. The current through the voice coil 126 may generate variable magnetic field that interacts with the magnet 128 to cause the voice coil 126, and resultingly the sound-generating component 120, to move to generate audible sound corresponding to the audio content.

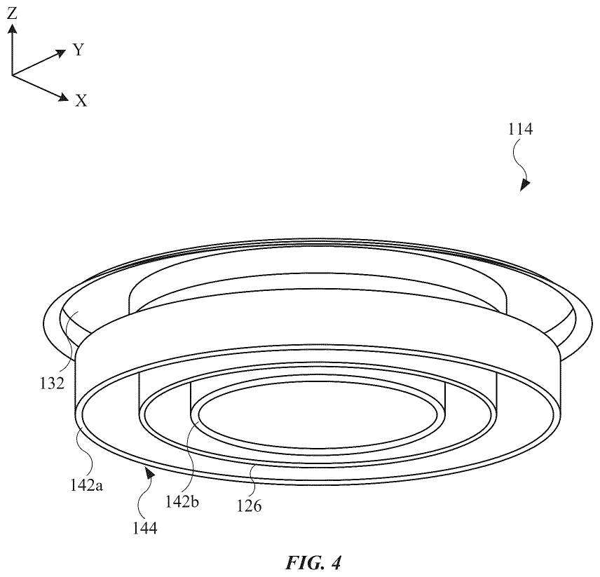

FIG. 3 illustrates a top view of the audio speaker 114, in accordance with one or more implementations of the present disclosure. As shown, the audio speaker 114 may include a diaphragm 132 (e.g., an implementation of the sound-generating component 120). The audio speaker 114 may also include a surround 134 that extends around a periphery of the diaphragm 132 and that movably suspends the diaphragm 132. In one or more implementations, the diaphragm 132 may include a dome portion 136 and a neck portion 138 that extends around a periphery of the dome portion 136. Based on the dome portion 136, the diaphragm 132 may include a dome shape. In one or more implementations, the surround 134 may extend from the diaphragm 132 (e.g., from the neck portion 138) to a support structure 140. The support structure 140 may be a fixed support structure (e.g., fixed to and/or relative to other portions of the audio speaker assembly, such as an audio speaker frame or an audio speaker housing, and/or fixed to and/or relative to other portions or components of the device in which the audio speaker 114 is implemented). The surround 134 may be formed from a flexibly resilient material that movably suspends the diaphragm 132 with respect to other components of the audio speaker, such as the neck portion 138 and/or one or more fixed magnets (e.g., the magnet 128 shown in FIG. 2).

FIG. 4 illustrates a bottom perspective view of the audio speaker 114, in accordance with one or more implementations of the present disclosure. As shown in FIG. 4, the audio speaker 114 may include a magnet 142a and a magnet 142b, each of which may be implementations the magnet 128 (shown in FIG. 2). As shown, the magnet 142a and 142b are separated by a gap 144 within which the voice coil 126 is disposed. In the configuration of FIG. 4, when a current is provided through the voice coil 126, a resulting magnetic field, in the form of an alternating magnetic field that changes based on the current through the voice coil 126, interacts with the magnets 142a and 142b to move the voice coil 126 in two different directions (e.g., along a positive and negative direct along a Z-axis of Cartesian coordinates), and resultingly, the diaphragm 132 that is coupled with the voice coil 126. The magnet 142a and the magnet 142b may take the form of two separate magnets, or may take the form of two portions of a single (e.g., contiguous, monolithic magnet) with the gap 144 between the two portions (represented by the magnet 142a and the magnet 142b).

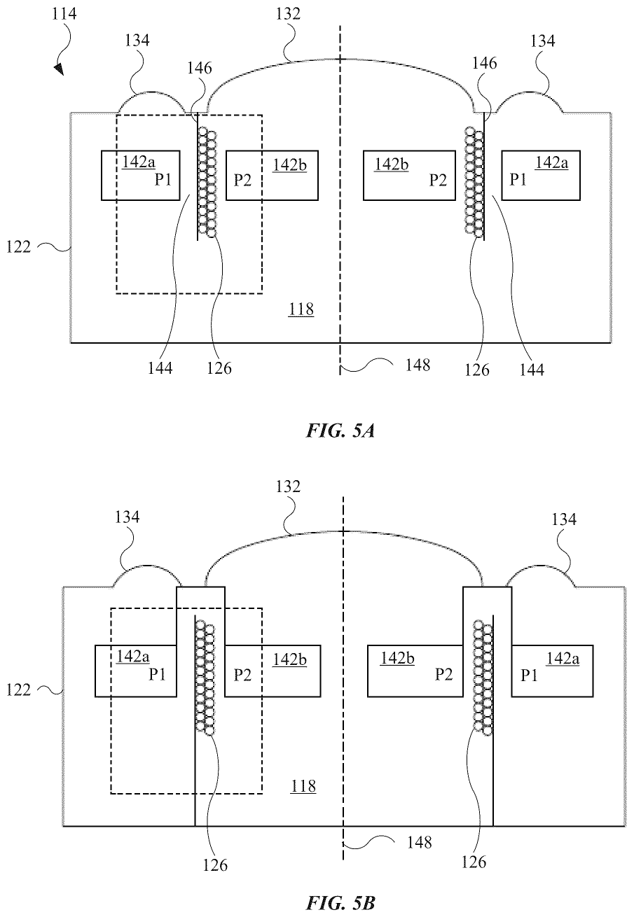

FIG. 5A illustrates a cross sectional view of the audio speaker 114, showing additional details of the voice coil 126, in accordance with one or more implementations of the present disclosure. As shown, the voice coil 126 may be formed on (e.g., mounted to) a voice coil former 146. The voice coil 126 may be formed from several windings that wind in a circular or generally circular manner around the magnet 142b. Further, the magnet 142b may be centered within a bore formed by the voice coil 126. Also, the voice coil 126 is disposed within the gap 144 between the magnets 142a and 142b. In one or more implementations, the audio speaker 114 may be substantially symmetric about an axis 148 (e.g., vertical axis). The voice coil 126 is movably suspended with respect to the magnets 142a and 142b. Also, each of the magnets 142a and 142b are implemented as fixed magnets (e.g., magnets that are fixed in place relative to the audio speaker housing 122, and/or relative to the housing 106 of the electronic device 100 shown in FIG. 1).

The magnet 142a may include a pole P1 external to, facing, and separated from, the voice coil 126. The pole P1 may take the form of a magnetic polarity (e.g., a North Pole). The magnet 142b may include a pole P2 internal to, facing, and separated from, the voice coil 126. The pole P2 may take the form of a different magnetic polarity (e.g., a South Pole). Accordingly, the pole P1 and the pole P2 may include an opposite or opposing magnetic polarity.

FIG. 5B illustrates an additional cross sectional side view of the audio speaker 114, showing an alternative implementation of the audio speaker 114, in accordance with one or more aspects of the present disclosure. In the implementation shown in FIG. 5B, the magnets 142a and 142b are implemented as movable magnets and the voice coil 126 is implemented as a fixed voice coil. The voice coil 126 may be fixed (e.g., to the audio speaker housing 122 or to another fixed structure of the audio speaker 114 and/or the electronic device 100 shown in FIG. 1), and the magnet 142a and 142b may be movably suspended relative to the voice coil 126. In this example, the diaphragm 132 is mechanically coupled to the magnets 142a and 142b. When a current is provided through the voice coil 126, a resulting magnetic field interacts with the magnets 142a and 142b to move the magnets 142a and 142b (e.g., along a direction parallel to the axis 148), and resultingly, the move diaphragm 132 that is attached to the magnet 140a and the magnet 140b.

In either implementation shown in FIG. 5A and FIG. 5B, the back volume 118 (e.g., as defined by the audio speaker housing 122), the diaphragm 132, and the surround 134 may collectively form a sealed volume that traps air therewithin. The trapped air may generate an air “spring” that generates an added stiffness by which the diaphragm 132 is movably mounted by the surround 134.

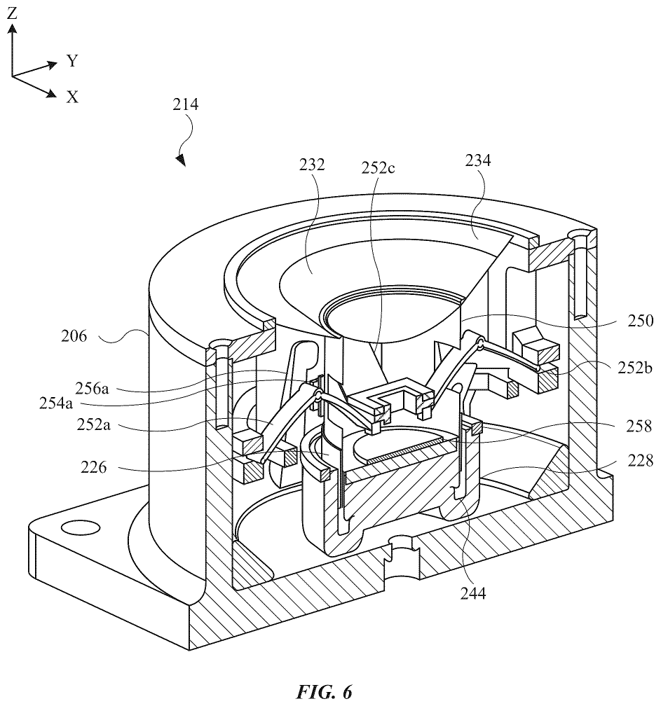

In accordance with aspects of the present disclosure, audio speakers may be provided with one or more hinges designed to reduce the stiffness by which a diaphragm is movably mounted by a surround. The hinges may effectively cancel, or at least offset or minimize, the stiffness generated by the trapped air in a back volume of an audio speaker. Various examples of such hinges shown and/or described herein are shown in FIGS. 6-13. For purposes of simplicity, various aspects of the examples shown and/or described in FIGS. 6-3 are described with respect to the implementation of at least FIGS. 4 and 5A in which a voice coil is movably suspended and configured to move relative to one or more fixed magnets when a current is passed through the voice coil. However, it is understood that any of the features in examples of FIGS. 6-9 may be implemented in the configuration of FIG. 5B, in which magnets (e.g., the magnets 142a and 142b) take the form of movable magnets that are movably suspended and configured to move relative to the voice coil when a current is passed through the voice coil.

FIG. 6 illustrates a partial cross sectional view of an example of an audio speaker 214 with several hinges, in accordance with one or more aspects of the present disclosure. The audio speaker 214 may include components such as a housing 206, a diaphragm 232, and a surround 234 coupled with the housing 206 and the diaphragm 232. The audio speaker 214 may further include a voice coil 226 and a magnet 228. The voice coil 226 may take the form of a wound metal wire. The magnet 228 may take the form of one or more permanent magnets. As shown, the magnet 228 includes a gap 244 and the voice coil 226 is positioned, or at least partially positioned, in the gap 244 of the magnet 228. The audio speaker 214 may further include a carrier assembly 250 that is coupled with the voice coil 226 and the diaphragm 232. The carrier assembly 250 may include one or more component and may define in part a rear suspension of the audio speaker 214.

The audio speaker 214 may further include a hinge 252a, a hinge 252b, and a hinge 252c. Although not shown, an additional (e.g., fourth) hinge may be included. The characteristics and features described for the hinges 252a, 252b, and 252c may apply to any hinges not shown in FIG. 6. The hinges 252a, 252b, and 252c may (collectively) center the voice coil 226 within the housing 206 along multiple axes including the X-, Y-, and Z-axes. As shown, the hinges 252a, 252b, and 252c may be located in a back volume of the audio speaker 214. In some instances, air trapped within the housing 206 may create stiffness. The hinges 252a, 252b, and 252c may limit or prevent issues such as rocking or shearing during movement of the voice coil 226. Beneficially, each of the hinges 252a, 252b, and 252c may offset (e.g., cancel or partially cancel) the stiffness caused by the air. As a result, each of the hinges 252a, 252b, and 252c may function as spring. In one or more implementations, each of the hinges 252a, 252b, and 252c (as well as other hinges shown and/or described herein) takes the form of a living hinge. Accordingly, each of the hinges 252a, 252b, and 252c may be formed from a unitary piece of material that allows each of the hinges 252a, 252b, and 252c to bend or flex. Further, each of the hinges 252a, 252b, and 252c may be formed through a molding operation, including injection molding as a non-limiting example. Also, in one or more implementations, the hinges 252a, 252b, and 252c (as well as other hinges shown and/or described herein) are formed from multiple pieces, which may include multiple molded pieces. In this regard, each of the hinges 252a, 252b, and 252c may be mechanically coupled together.

Each of the hinges 252a, 252b, and 252c may couple with the housing 206 and the carrier assembly 250. In this regard, movement of the voice coil 226 (e.g., along either direction of the Z-axis), due to electrical current flow through the voice coil 226 causing an electromagnet, may cause a corresponding movement of the carrier assembly 250 and each of the hinges 252a, 252b, and 252c. However, it is generally desired that the voice coil 226 remain at least partially within the gap 244 of the magnet 228. Each of the hinges 252a, 252b, and 252c may limit or constrain movement of the voice coil 226, thus maintain the voice coil 226 in a desired position (e.g., at least partially within the gap 244).

In one or more implementations, operating the voice coil 226 may include performing centering operations (e.g., by controlling a current through the voice coil 226, and/or via another centering system or component) to hold the voice coil 226 at the centered position shown in FIG. 6 both in a direction parallel to the Z-axis and a direction perpendicular to the Z-axis. For example, the audio speaker 214 may provide a motor strength, or BL (where B refers to the magnetic field strength and L refers to the length of the voice coil 226), that centers the voice coil 226. Moreover, required BL may be a function of the distance away from the centered position of the voice coil 226. Accordingly, these centering operations may consume power and/or utilize additional speaker components, particularly for greater distances.

In some instances, the travel (e.g., Z-axis travel) of the voice coil 226 may nonetheless be displaced such that the BL is insufficient to center the voice coil 226. Moreover, the hinges 252a, 252c, and 252c may be unable to provide the mechanical force needed to center the voice coil 226. In this regard, the audio speaker 214 may include a pin 254a (representative of one or more additional pins) and a stop mechanism 256a (representative of one or more stop mechanisms). As non-limiting examples, the pin 254a may include an added structure or extension, and the stop mechanism 256a may include a hook, an L-shaped structure, or the like. The pin 254a may couple with the carrier assembly 250 and the stop mechanism 256a may couple with the housing 206. As a result, the pin 254a may move, along with the voice coil 226, the carrier assembly 250, and the hinges 252a, 252b, and 252c, relative to the stop mechanism 256a. In this regard, movement of the pin 254a along the positive direction of the Z-axis may cause the pin 254a to contact the stop mechanism 256a, thus limiting further movement of the voice coil 226, the carrier assembly 250, and the hinges 252a, 252b, and 252c along the positive direction of the Z-axis.

Additionally, the voice coil 226, the carrier assembly 250, and the hinges 252a, 252b, and 252c may move along the opposite direction (e.g., negative direction along the Z-axis). The audio speaker 214 may further include a stop mechanism 258 coupled with (e.g., positioned on) the magnet 228. As a non-limiting example, the stop mechanism 258 may include a pad, a plate, a buffer, or the like. During movement, the carrier assembly 250 may contact the stop mechanism, thus preventing further movement of the carrier assembly 250, along with the voice coil 226 and the hinges 252a, 252b, and 252c.

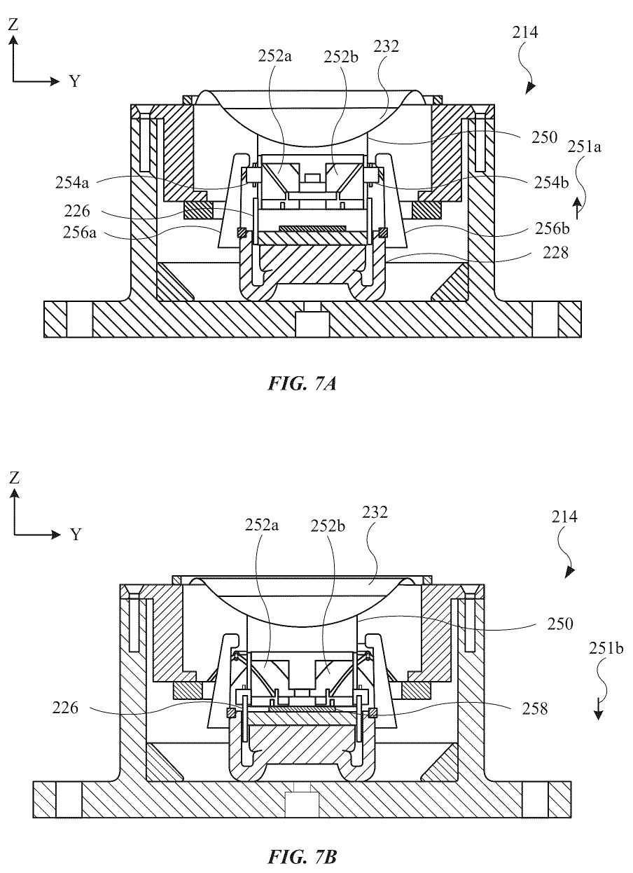

FIG. 7A and FIG. 7B illustrate partial cross sectional views of the audio speaker 214, showing exemplary movement of several components, in accordance with one or more aspects of the present disclosure. The characterized movement of the hinges 252a and 252b may apply to other hinges of the audio speaker 214. Referring to FIG. 7A, electrical current passing through the voice coil 226 in one direction causes the voice coil 226 to form electromagnet, thus causing a magnetic repulsion with the magnet 228. This in turn causes the voice coil 226 to move a distance 251a along the positive direction of the Z-axis, and further causes the carrier assembly 250 and the diaphragm 232 move in the same direction. Based on the coupling between the carrier assembly 250 and the hinges 252a and 252b, the hinges 252a and 252b may move (e.g., by bending or flexing) along the same direction. Additionally, the pin 254a and a pin 254b, each coupled with the carrier assembly 250 and the voice coil 226, move in the same direction until the pin 254a and the pin 254b contact the stop mechanism 256a and a stop mechanism 256b, respectively, as shown in FIG. 7A. The contact between the pins 254a and 254b and the stop mechanisms 256a and 256b limit additional travel.

Referring to FIG. 7B, electrical current passing through the voice coil 226 in the opposite direction causes the voice coil 226 to form electromagnet of a different polarity, thus causing a magnetic attraction to the magnet 228. This in turn causes the voice coil 226, diaphragm 232, and the carrier assembly 250 to move a distance 251b in the opposite direction (e.g., negative Z-direction). Based on the coupling between the carrier assembly 250 and the hinges 252a and 252b, the hinges 252a and 252b may move (e.g., by bending or flexing) along the same direction. This movement may continue until the carrier assembly 250 contacts the stop mechanism 258.

In one or more implementations, each of the hinges 252a and 252b (representative of additional hinges of the audio speaker 214) may take the form of a bi-stable hinge. In this regard, the hinges 252a and 252b are designed to remain in two fixed positions. Each fixed position may require the hinges 252a and 252b to travel to a threshold distance. However, based on the location of the stop mechanism 256a and the stop mechanism 258, each of the hinges 252a and 252b may remain positioned between each of their respective stable positions such that the hinges 252a and 252b do not reach their respective threshold distances. Put another way, each of the hinges 252a and 252b may not achieve their respective stable positions based in part on the location of the stop mechanism 256a and the stop mechanism 258. However, by engaging either of the aforementioned stop mechanisms, the hinges 252a and 252b do not travel far enough to permit the voice coil 226 to travel beyond a distance in which an applied centering current (forming the BL) cannot return/re-center the voice coil 226.

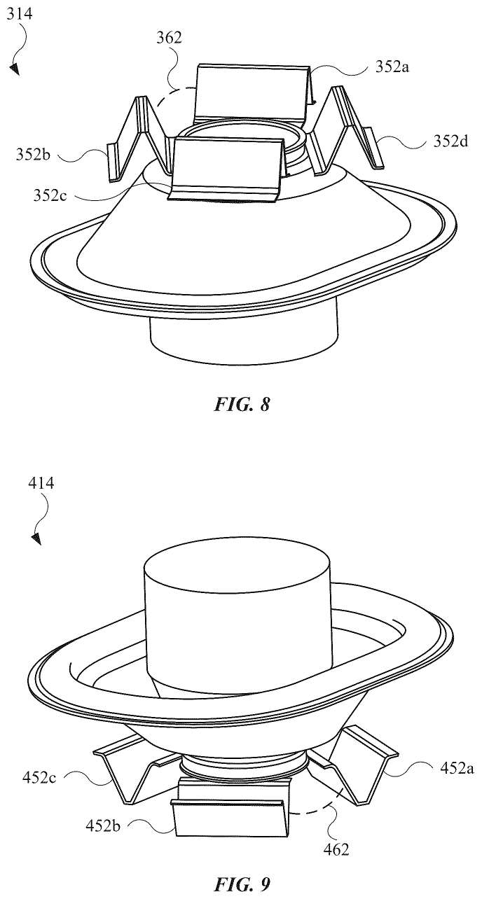

FIGS. 8-11C show and describe audio speakers with hinges. While not expressly shown, the audio speakers in FIGS. 8-11C may include any features shown and/or described for the audio speaker 114 (e.g., shown in FIG. 5A) and/or the audio speaker 214 (e.g., shown in FIG. 6).

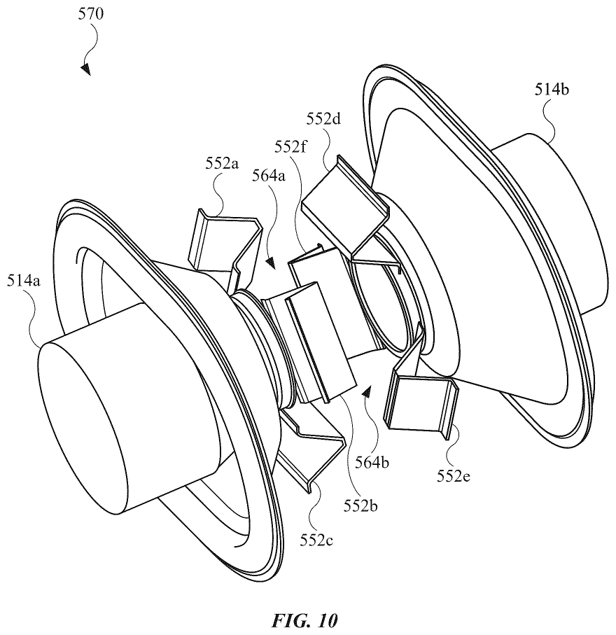

FIG. 8 and FIG. 9 illustrate perspective views of alternate examples of audio speakers, in accordance with one or more aspects of the present disclosure. Referring to FIG. 8, an audio speaker 314 includes a hinge 352a, a hinge 352b, a hinge 352c, and a hinge 352d. Each of the hinges 352a, 352b, 352c, and 352d may be equally spaced apart. For example, the hinge 352a is separated from the hinge 352b by an angle 362 (representative of other angles between hinges in FIG. 8). In this regard, the hinges 352a and 352b are separated by a gap defined by the angle 362. Based on the number of hinges (e.g., four), the angle 362, representative of respective angles between the remaining hinges, is 90 degrees.

Referring to FIG. 9, an audio speaker 414 includes a hinge 452a, a hinge 452b, and a hinge 452c. Each of the hinges 452a, 452b, and 352c may be equally spaced apart. For example, the hinge 452a is separated from the hinge 452b by an angle 462 (representative of other angles between hinges in FIG. 9). In this regard, the hinges 452a and 452b are separated by a gap defined by the angle 462. Based on the number of hinges (e.g., three), the angle 462, representative of respective angles between the remaining hinges, is 120 degrees.

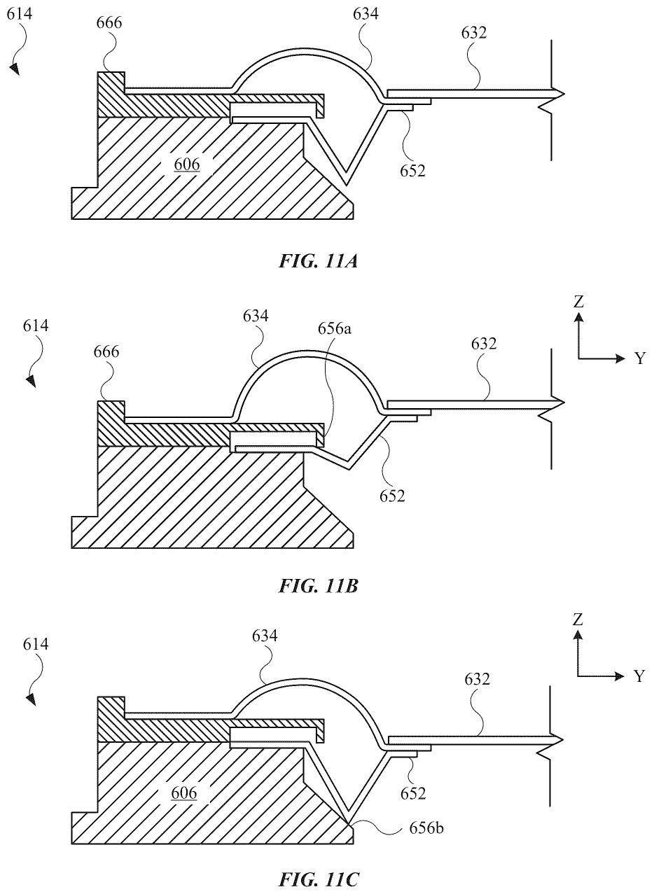

FIG. 10 illustrates a perspective view of an audio speaker assembly 570, in accordance with one or more aspects of the present disclosure. As shown, the audio speaker assembly 570 includes an audio speaker 514a and an audio speaker 514b. The audio speaker assembly 570 may further include a housing (not shown in FIG. 10) that encloses, or at least partially encloses, the audio speakers 514a and 514b. Each of the audio speakers 514a and 514b may include several hinges. For example, the audio speaker 514a may include a hinge 552a, a hinge 552b, and a hinge 552c. Each of the hinges 552a, 552b, and 552c may be equally spaced apart. Based on the number of hinges (e.g., three), each of the hinges 552a, 552b, and 552c may be equally spaced apart by 120 degrees. Similarly, the audio speaker 514b may include a hinge 552d, a hinge 552e, and a hinge 552f, each of which are spaced apart by 120 degrees.

The separation of hinges may form gaps. For example, the separation of the hinges 552a and 552b (of the audio speaker 514a) forms a gap 564a (representative of additional gaps). Similarly, the separation of the hinges 552a and 552b (of the audio speaker 514b) forms a gap 564b (representative of additional gaps). The gaps 564a and 564b may provide a space into which a hinge may enter. For example, the gap 564a provide a space into which the hinge 552d (of the audio speaker 514b) may enter during movement of the hinge 552d (previously shown and described for hinges). Similarly, the gap 564b provide a space into which the hinge 552b (of the audio speaker 514a) may enter during movement of the hinge 552b (previously shown and described for hinges). In order for the hinges of a speaker assembly to enter a gap of the other speaker assembly, the respective hinges may be offset. For example, the hinges 552a, 552b, and 552c (each spaced 120 degrees apart) of the audio speaker 514a may be offset (e.g., rotated) by 60 degrees relative to the hinges 552d, 552e, and 552f (each spaced 120 degrees apart) of the audio speaker 514b. The entry of hinges into a gap may occur based on movement of respective voice coils and diaphragms (not shown in FIG. 10) of the audio speakers 514a and 514b. Beneficially, the audio speakers 514a and 514b may be positioned closer together, and the audio speaker assembly 570 may provide a relatively small footprint.

FIG. 11A, FIG. 11B, and FIG. 11C illustrate partial cross sectional views of an alternate example of an audio speaker 614, showing a hinge in a different location, in accordance with one or more aspects of the present disclosure. The audio speaker 614 may include a housing 606 and a platform 666 coupled with the housing 606. Alternatively, in one or more implementations, the housing 606 defines a platform (e.g., the platform 666) such that the housing is a unitary housing structure with features corresponding to the platform 666. The audio speaker 614 may further include a diaphragm 632 and a surround 634 coupled with the diaphragm 632. Additionally, the audio speaker 614 may further include a hinge 652 (representative of one or more additional hinges not shown in FIGS. 11A-11C). As shown, the system, including the diaphragm 632 and the hinge 652, is in its resting position in FIG. 11A. A “resting position” may refer to a steady-state position when a hinge (e.g., the hinge 652) is installed in an audio speaker (e.g., the audio speaker 614) positions a voice coil without magnetically-derived forces (e.g., magnetic attraction and repulsion) act on a voice coil and, indirectly, the hinge 652.

Referring to FIG. 11B, the diaphragm 632 and the surround 634 move along a positive direction of the Z-axis. In order to facilitate movement of the diaphragm 632, the surround 634 may include a reduced stiffness. As shown, the platform 666 includes a stop mechanism 656a. In this regard, the movement of the hinge 652 is limited based on contact with the stop mechanism 656a, thus preventing additional movement of the hinge 652 along the positive direction of the Z-axis. This may further prevent corresponding movement of the diaphragm 632 and a voice coil (not shown in FIG. 11B).

Referring to FIG. 11C, the diaphragm 632 and the surround 634 move along a negative direction of the Z-axis. As shown, the housing 606 includes a surface that defines a stop mechanism 656b. In this regard, the movement of the hinge 652 is limited based on contact with the stop mechanism 656b, thus preventing additional movement of the hinge 652 along the negative direction of the Z-axis. This may further prevent corresponding movement of the diaphragm 632 and a voice coil (not shown in FIG. 11C).

The exemplary embodiment shown in FIGS. 11A-11C illustrate the hinge 652 contacting existing features (e.g., housing 606, platform 666 of the audio speaker 614) as opposed to added components, such as pins (e.g., pins 254a and 254b shown in FIG. 7A). Also, contrary to prior embodiments in which hinges are positioned at a rear portion or rear suspension, the exemplary embodiment shown in FIGS. 11A-11C illustrates a hinge positioned at a front portion or front suspension of the audio speaker 614.

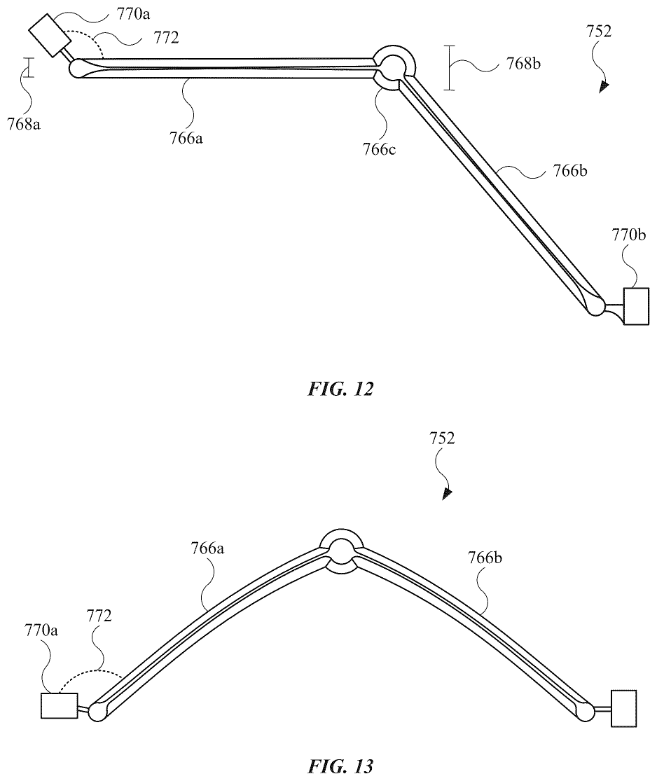

FIGS. 12 and 13 illustrate an example of a hinge 752. Hinges shown and/or described herein may include any features shown and/or described for the hinge 752.

FIG. 12 illustrates a side view of an example of a hinge 752, in accordance with one or more aspects of the present disclosure. The hinge 752 may be formed by a molding operation (e.g., injection molding operation). As a result, the hinge 752 may include one or more amorphous regions to resist fatigue during use, as well as one or semi-crystalline regions to increase the modulus of the hinge 752. As shown, the hinge 752 includes a portion 766a, a portion 766b, and a portions 766c positioned between the portions 766a and 766b. Each of the portions 766a and 766b are designed to bend or flex relative to each other. The hinge 752 may include different dimensions (e.g., different thicknesses) in different regions. For example, each of the portions 766a and 766b may include a dimension 768a (e.g., thickness). Accordingly, the portions 766a and 766b may include the same thickness. Also, the portion 766c may include a dimension 768b (e.g., thickness) greater than the dimension 768a. Accordingly, the portion 766c is thicker than each of the portions 766a and 766b, or conversely, each of the portions 766a and 766b is thinner than the portion 766c. In one or more implementations, the dimension 768a of each of the portions 766a and 766b may gradually increase (e.g., become thicker) toward the portion 766c. The portions 766a, 766b, and 766c generally represent a hinge body defining the hinge 752. As shown, the portions 766a and 766b define an initial bent configuration of the hinge 752.

Additionally, the hinge 752 may include a connector 770a and a connector 770b (e.g., extensions). The connectors 770a and 770b are designed to secure the hinge 752 to a component(s) of an audio speaker (e.g., audio speaker 214 shown in FIG. 6). As shown, the connector 770a is formed at an angle 772 with respect to the portion 766a. The angle 772 may be approximately in the range of 90 to 160 degrees. Additionally, for an audio speaker with multiple hinges similar to that of the hinge 752, each of the hinges may be molded together with a carrier assembly (e.g., carrier assembly 250 shown in FIG. 6). In this regard, an audio speaker may include a unitary structure with a carrier assembly and multiple hinges.

FIG. 13 illustrates a side view of an example of the hinge 752, showing a position of the hinge 752 when assembled in an audio speaker, in accordance with one or more aspects of the present disclosure. As shown, the portions 766a and 766b bent, and the hinge 752 defines a different bent configuration. Also, the hinge 752 may be in its resting position and magnetically-based forces are not acting on a voice coil, and indirectly, the hinge 752. Rather than form the connector 770a in-plane (e.g., at 180 degrees) with respect to the portion 766a, the connector 770a is pre-formed at the angle 772 to take on the position (e.g., between the connector 770a and the portion 766a) when the hinge 752 is in its resting position. Put another way, the connector 770a may require little or no bending (and associated stresses) when the hinge 752 is in the resting position, based on the connector 770a being pre-formed with the angle 772 relative to the portion 766a. Beneficially, less unwanted force is applied to the hinge 752 in the resting position.

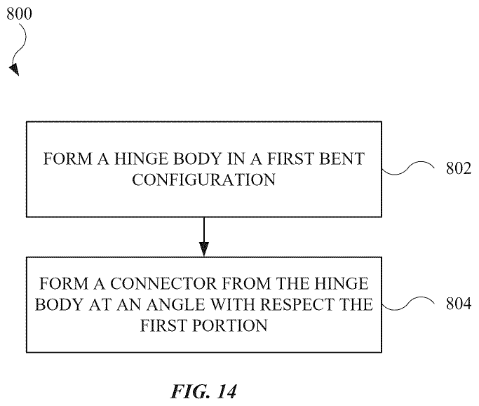

FIG. 14 illustrates a flow diagram of an example of a process 800 for manufacturing a hinge for an audio speaker, in accordance with one or more implementations of the present disclosure. For explanatory purposes, the process 800 is primarily described herein with reference to audio speakers shown and/or described in FIGS. 1-12. However, the process 800 is not limited to the audio speakers shown and/or described in FIGS. 1-12, and one or more blocks (or operations) of the process 800 may be performed by one or more other components and other suitable audio transducers. Further for explanatory purposes, the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

At block 802, a hinge body is formed in a first bent configuration. The hinge body may include a first portion that includes a first thickness, a second portion that includes a second thickness greater than the first thickness, and a third portion that includes the first thickness.

At block 804, a connector from the hinge body at an angle with respect the first portion is formed. In one or more implementations, in response to the audio speaker in a steady-state position, the hinge body is in a second bent configuration and the connector is positioned relative to the first portion by the angle.

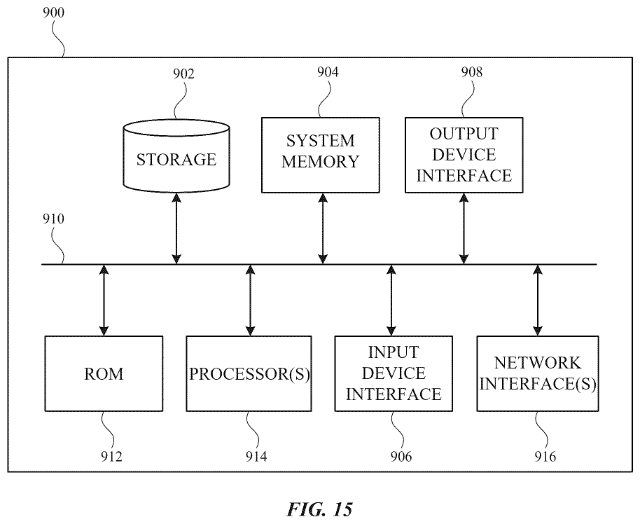

FIG. 15 illustrates an electronic system 900 with which one or more implementations of the subject technology may be implemented. The electronic system 900 can be, and/or can be a part of, the electronic device 100 as shown in FIG. 1. The electronic system 900 may include various types of computer readable media and interfaces for various other types of computer readable media. The electronic system 900 includes a bus 910, one or more processing units 914, a system memory 904 (and/or buffer), a ROM 912, a permanent storage device 902, an input device interface 906, an output device interface 908, and one or more network interfaces 916, or subsets and variations thereof.

The bus 910 collectively represents all system, peripheral, and chipset buses that communicatively connect the numerous internal devices of the electronic system 900. In one or more implementations, the bus 910 communicatively connects the one or more processing units 914 with the ROM 912, the system memory 904, and the permanent storage device 902. From these various memory units, the one or more processing units 914 retrieves instructions to execute and data to process in order to execute the processes of the subject disclosure. The one or more processing units 914 can be a single processor or a multi-core processor in different implementations.

The ROM 912 stores static data and instructions that are needed by the one or more processing units 914 and other modules of the electronic system 900. The permanent storage device 902, on the other hand, may be a read-and-write memory device. The permanent storage device 902 may be a non-volatile memory unit that stores instructions and data even when the electronic system 900 is off. In one or more implementations, a mass-storage device (such as a magnetic or optical disk and its corresponding disk drive) may be used as the permanent storage device 902.

In one or more implementations, a removable storage device (such as a flash drive, and its corresponding disk drive) may be used as the permanent storage device 902. Like the permanent storage device 902, the system memory 904 may be a read-and-write memory device. However, unlike the permanent storage device 902, the system memory 904 may be a volatile read-and-write memory, such as random access memory. The system memory 904 may store any of the instructions and data that one or more processing units 914 may need at runtime. In one or more implementations, the processes of the subject disclosure are stored in the system memory 904, the permanent storage device 902, and/or the ROM 912 (which are each implemented as a non-transitory computer-readable medium). From these various memory units, the one or more processing units 914 retrieves instructions to execute and data to process in order to execute the processes of one or more implementations.

The bus 910 also connects to the input device interface 906 and output device interface 908. The input device interface 906 enables a user to communicate information and select commands to the electronic system 900. Input devices that may be used with the input device interface 906 may include, for example, alphanumeric keyboards and pointing devices (also called “cursor control devices”). The input device interface 906 may enable, for example, the display of images generated by electronic system 900. Output devices that may be used with the input device interface 906 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 910 may also couple the electronic system 900 to one or more networks and/or to one or more network nodes, such as the electronic device 100 shown in FIG. 1, through the one or more network interfaces 916. In this manner, the electronic system 900 can be a part of a network of computers (such as a LAN, a wide area network (“WAN”), or an Intranet, or a network of networks, such as the Internet. Any or all components of the electronic system 900 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, and/or any other optical or magnetic media. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Various examples of aspects of the disclosure are described below as clauses for convenience. These are provided as examples, and do not limit the subject technology.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An audio speaker, comprising:
a voice coil;
a first hinge coupled with the voice coil, the first hinge configured to limit the voice coil to travel a first distance;
a pin coupled with the voice coil; and
a first stop mechanism, wherein the first stop mechanism is configured to contact the pin and limit the voice coil to travel a second distance less than the first distance.

2. The audio speaker of claim 1, wherein:
the first stop mechanism is further configured limit the first hinge to the second distance, and
the second distance is less than a threshold distance of travel of the first stop mechanism.

3. The audio speaker of claim 1, further comprising:
a housing; and
a second hinge coupled with the voice coil, wherein the first hinge and the second hinge are configured center the voice coil within the housing along a first axis.

4. The audio speaker of claim 3, wherein the first hinge and the second hinge are configured center the voice coil within the housing along a second axis different from the first axis.

5. The audio speaker of claim 3, further comprising a magnet, wherein the first hinge and the second hinge are configured to center the voice coil with respect to the magnet.

6. The audio speaker of claim 3, wherein the first hinge comprises:
a first portion coupled with the voice coil and having a first thickness; and
a second portion and having a second thickness different from the first thickness.

7. The audio speaker of claim 6, further comprising a third portion coupled with the housing and having the first thickness.

8. The audio speaker of claim 6, wherein the first thickness is less than the second thickness.

9. An audio speaker, comprising:
a voice coil;
a first hinge coupled with the voice coil, the first hinge configured to travel a first distance; and
a first stop mechanism coupled with a magnet, the first stop mechanism configured to limit the travel of the first hinge to a second distance less than the first distance.

10. The audio speaker of claim 9, further comprising a second stop mechanism coupled with the magnet, wherein:
the first stop mechanism is configured to limit the travel of the first hinge along a first direction, and
the second stop mechanism is configured to limit the travel of the first hinge along a second direction opposite the first direction.

11. The audio speaker of claim 9, further comprising:
a housing; and
a second hinge coupled with the voice coil, wherein the first hinge and the second hinge are configured center the voice coil within the housing along a first axis.

12. The audio speaker of claim 11, wherein the first hinge and the second hinge are configured center the voice coil within the housing along a second axis different from the first axis.

13. The audio speaker of claim 11, wherein the first hinge and the second hinge are configured to center the voice coil with respect to the magnet.

14. The audio speaker of claim 11, wherein the first hinge comprises:
a first portion coupled with the voice coil and having a first thickness; and
a second portion and having a second thickness different from the first thickness.

15. The audio speaker of claim 14 further comprising a third portion coupled with the housing and having the first thickness.

16. The audio speaker of claim 15, wherein the first thickness is less than the second thickness.

17. An electronic device, comprising:
an audio speaker, comprising:
a voice coil;
a first hinge coupled with the voice coil; and
a second hinge coupled with the voice coil wherein the first hinge and the second hinge are configured center the voice coil along a first axis and a second axis different from the first axis.

18. The electronic device of claim 17, further comprising:
a first stop mechanism configured to limit travel of the first hinge and the second hinge along a first direction, and
a second stop mechanism configured to limit the travel of the first hinge and the second hinge along a second direction opposite the first direction.

19. The electronic device of claim 17, wherein the first hinge comprises:
a first portion comprising a first thickness;
a second portion comprising a second thickness greater than the first thickness; and
a third portion comprising the first thickness, wherein the second portion is positioned between the first portion and the second portion.

20. The electronic device of claim 17, further comprising a housing, wherein:
the housing defines a back volume, and
the first hinge and the second hinge are disposed in the back volume.
